(19) United States
(12) Patent Application Publication
(10) Pub. No.: US 2022/0414533 A1
(43) Pub. Date: Dec. 29, 2022

(54) AUTOMATED HYPERPARAMETER TUNING IN MACHINE LEARNING ALGORITHMS

(71) Applicant: Dell Products L.P., Round Rock, TX (US)

(72) Inventors: Bijan Kumar Mohanty, Austin, TX (US); Harish Mysore Jayaram, Cedar Park, TX (US); Hung T. Dinh, Austin, TX (US)

(21) Appl. No.: 17/362,114

(22) Filed: Jun. 29, 2021

(51) Int. Cl. G06N 20/00

(52) U.S. Cl. CPC G06N 20/00

(57) ABSTRACT

Methods, apparatus, and processor-readable storage media for automated hyperparameter tuning in machine learning algorithms are provided herein. An example computer-implemented method includes identifying, for a machine learning algorithm, hyperparameters and values for each hyperparameter; determining a first value for a first hyperparameter by iterating through each value for the first hyperparameter, generating a version of the machine learning algorithm corresponding to each iteration, scoring each version, and identifying the first value based on the scoring; determining at least a second value for at least a second of the hyperparameters by iterating through each value for the hyperparameter(s), in conjunction with using the first value for the first hyperparameter, generating a version of the machine learning algorithm corresponding to each iteration, scoring each version, and identifying the at least a second value for the hyperparameter(s) based on the scoring; and automatically tuning the hyperparameters based on the determined values.

### FIELD

The field relates generally to information processing systems, and more particularly to using machine learning algorithms in such systems.

### BACKGROUND

Machine learning algorithms commonly include model parameters and model hyperparameters. Model parameters are typically learned from training data (e.g., in a linear regression, the coefficients are model parameters), while model hyperparameters typically vary from algorithm to algorithm and can be tuned in an attempt to optimize the performance and accuracy of the algorithm. Conventional algorithm management approaches can include trial-and-error-style tuning of hyperparameters, which is error-prone and labor-intensive. Also, conventional algorithm management approaches can include using algorithms (e.g., GridSearchCV, RandomSearchCV, etc.) to attempt to identify hyperparameter values for a given machine learning algorithm. However, such algorithms rely on random or user-selected subsets of values, resulting in high computational costs and frequent errors, as sub-optimal values may be selected for processing.

### SUMMARY

Illustrative embodiments of the disclosure provide techniques for automated hyperparameter tuning in machine learning algorithms. An exemplary computer-implemented method includes identifying, for a given machine learning algorithm, two or more hyperparameters and at least a portion of possible values for each of the two or more hyperparameters, and determining a first value, among the at least a portion of possible values, for a first of the two or more hyperparameters by iterating through each of the at least a portion of the possible values for the first hyperparameter, generating a version of the given machine learning algorithm corresponding to each iteration, scoring each version of the given machine learning algorithm, and identifying the first value based on the scoring of each version. The method also includes determining at least a second value, among the at least a portion of possible values, for at least a second of the two or more hyperparameters by iterating through each of the at least a portion of the possible values for the at least a second of the two or more hyperparameters, with each iteration being carried out in conjunction with using the identified first value for the first hyperparameter, generating a version of the given machine learning algorithm corresponding to each iteration, scoring each version of the given machine learning algorithm, and identifying the at least a second value for the at least a second of the two or more hyperparameters based on the scoring of each version. Further, the method additionally includes automatically tuning the two or more hyperparameters of the given machine learning algorithm based at least in part on the determined first value and the determined at least a second value.

Illustrative embodiments can provide significant advantages relative to conventional algorithm management approaches. For example, problems associated with trial-and-error processes and computationally expensive techniques are overcome in one or more embodiments through determining optimized hyperparameter values in machine learning algorithms using an automated recursive mechanism.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated hyperparameter tuning in machine learning algorithms in an illustrative embodiment.

FIG. 2 shows example inner and outer loops of hyperparameters and values in an illustrative embodiment.

FIG. 3 shows a portion of a machine learning hyperparameter tuning algorithm in an illustrative embodiment.

FIG. 4 shows a portion of a machine learning hyperparameter tuning algorithm in an illustrative embodiment.

FIG. 5 shows a portion of a machine learning hyperparameter tuning algorithm in an illustrative embodiment.

FIG. 6 shows example pseudocode for implementing at least a portion of a machine learning hyperparameter tuning algorithm in an illustrative embodiment.

FIG. 7 shows an example code snippet for implementing at least a portion of a machine learning hyperparameter tuning algorithm without cross-validation in an illustrative embodiment.

FIG. 8 shows an example code snippet for implementing at least a portion of a machine learning hyperparameter tuning algorithm with cross-validation in an illustrative embodiment.

FIG. 9 is a flow diagram of a process for automated hyperparameter tuning in a machine learning algorithm in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

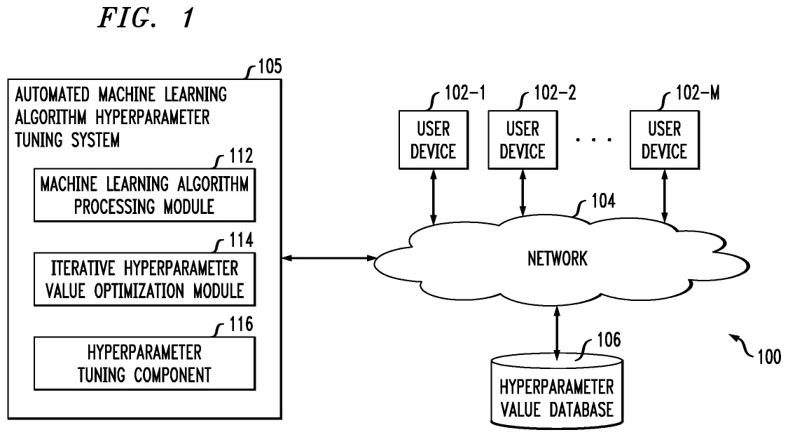

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated machine learning algorithm hyperparameter tuning system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (TP) or other related communication protocols.

Additionally, automated machine learning algorithm hyperparameter tuning system 105 can have an associated hyperparameter value database 106 configured to store data pertaining to hyperparameter values determined for one or more hyperparameters of one or more machine learning algorithms.

The hyperparameter value database 106 in the present embodiment is implemented using one or more storage systems associated with automated machine learning algorithm hyperparameter tuning system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated machine learning algorithm hyperparameter tuning system 105 are one or more input-output devices, which illustratively comprise keyboards, displays or other types of input-output devices in any combination. Such input-output devices can be used, for example, to support one or more user interfaces to automated machine learning algorithm hyperparameter tuning system 105, as well as to support communication between automated machine learning algorithm hyperparameter tuning system 105 and other related systems and devices not explicitly shown.

Additionally, automated machine learning algorithm hyperparameter tuning system 105 in the FIG. 1 embodiment is assumed to be implemented using at least one processing device. Each such processing device generally comprises at least one processor and an associated memory, and implements one or more functional modules for controlling certain features of automated machine learning algorithm hyperparameter tuning system 105.

More particularly, automated machine learning algorithm hyperparameter tuning system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated machine learning algorithm hyperparameter tuning system 105 to communicate over the network 104 with the user devices 102, and illustratively comprises one or more conventional transceivers.

The automated machine learning algorithm hyperparameter tuning system 105 further comprises machine learning algorithm processing module 112, iterative hyperparameter value optimization module 114, and hyperparameter tuning component 116.

It is to be appreciated that this particular arrangement of elements 112, 114 and 116 illustrated in the automated machine learning algorithm hyperparameter tuning system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated hyperparameter tuning in machine learning algorithms is presented by way of illustrative example only, and in other embodiments additional or alternative elements may be used. Thus, another embodiment includes additional or alternative systems, devices and other network entities, as well as different arrangements of modules and other components. For example, in at least one embodiment, automated machine learning algorithm hyperparameter tuning system 105 and hyperparameter value database 106 can be on and/or part of the same processing platform.

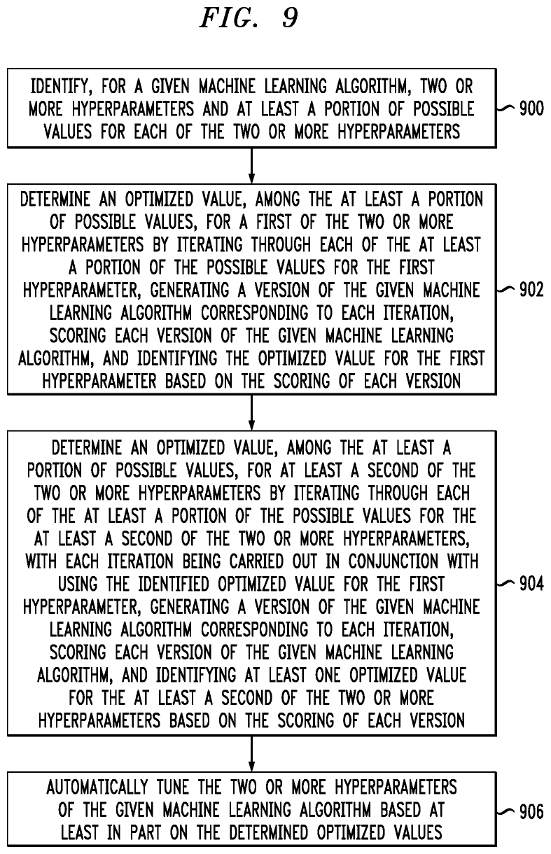

An exemplary process utilizing elements 112, 114 and 116 of an example automated machine learning algorithm hyperparameter tuning system 105 in computer network 100 will be described in more detail with reference to the flow diagram of FIG. 9.

Accordingly, at least one embodiment includes calculating one or more values (e.g., optimized values) of one or more hyperparameters of a given machine learning algorithm. As used herein, model parameters refer to configuration parameters, often internal to the model, having values that are estimated and/or determined using training data of the model. Additionally, as used herein, hyperparameters refer to adjustable configurations, often external to the model, that can be tuned to improve performance of the model (and whose values are not estimated and/or determined using training data).

As detailed herein, optimized values of a hyperparameter will typically lead to better performance and accuracy of the corresponding machine learning algorithm (e.g., support vector machines (SVM), a random forest algorithm, a gradient boosting algorithm, a k-means clustering algorithm, density-based spatial clustering of applications with noise (DBSCAN), an agglomerative clustering algorithm, a neural network, etc.). Also, as used herein, an “optimized” value is to be broadly construed herein to encompass a particular value, and is not required, for example, to equate to a maximum or minimum value.

The performance and accuracy of such algorithms can impact, in many use case examples, related revenues and reduce resolution times. Commonly, once a particular algorithm is selected and a model is created, data scientists attempt to implement hyperparameter tuning (that is, the active setting of particular values for one or more hyperparameters) of the model. By way merely of example, three potential hyperparameters for a gradient boosting regressor algorithm with the corresponding range of values can include the following:

criterion: ‘mse,’ ‘mae,’ ‘Friedman_mse;’

max_features: ‘auto,’ ‘sqrt,’ ‘log 2;’ and

min_samples_leaf: [1, 2, 3, 4, 5, 6, 7, 8, 9, 10, 11].

At least one embodiment includes efficiently identifying optimized values of one or more hyperparameters of a given machine learning algorithm (such as, for example, the above-noted gradient boosting regressor algorithm) using an iterative approach for each hyperparameter. Such an approach includes determining an optimized value for a first hyperparameter, and using that determined value for the first hyperparameter while determining an optimized value for the next/second hyperparameter, and so on. Additionally, such an approach can, for example, significantly reduce the number of iterations required by a GridSearchCV model and eliminate the randomness of a RandomSearchCV model.

In any machine learning algorithm, the number of hyperparameters can vary, and the value(s) of each hyperparameter can vary as well. The value(s) can be categorical (e.g., values such as ‘mse,’ ‘mae,’ etc.) or numerical (e.g., values between 1 and 11).

Accordingly, as noted above, one or more embodiments include starting with a first hyperparameter (referred to in one or more examples herein as paramN) and looping and/or iterating through the values of that hyperparameter (e.g., values ranging from 1 to M) while keeping the value of the other hyperparameter(s) fixed (e.g., at a first index). By creating versions of the algorithm using each of the various values of the first hyperparameter, generated scores of the versions are compared and the optimized value of hyperparameter is identified. In at least one embodiment, such scores represent model scores generated using training data or testing data. By way of illustration, after a given model is trained using training data, the score of the model can be calculated. Such a score can be calculated using the same training data (as used in training the model), wherein the model is queried for a prediction against that same training data. This score is often very high (e.g., close to 100%), which indicates that the model is well-trained. Additionally or alternatively, a test score prediction can be carried out against a portion of testing data, which can vary depending upon the type of model algorithm, training, etc.

Once the optimized value of paramN is identified, the value is stored and used in subsequent calculations. As such, in conjunction with the static optimized value of paramN, the above-described looping of the values of a different hyperparameter (e.g., paramN−1) is carried out and corresponding versions of the algorithm are created. The scores generated in connection with the various versions of the algorithm are then compared to identify the optimized value of that hyperparameter (e.g., paramN−1). In one or more embodiments, this process continues, incorporating an additional static optimized hyperparameter value with each iteration, until all hyperparameters are covered. At the end of the cycle, optimized values of all hyperparameters are identified and returned as the recommended values for that specific machine learning algorithm.

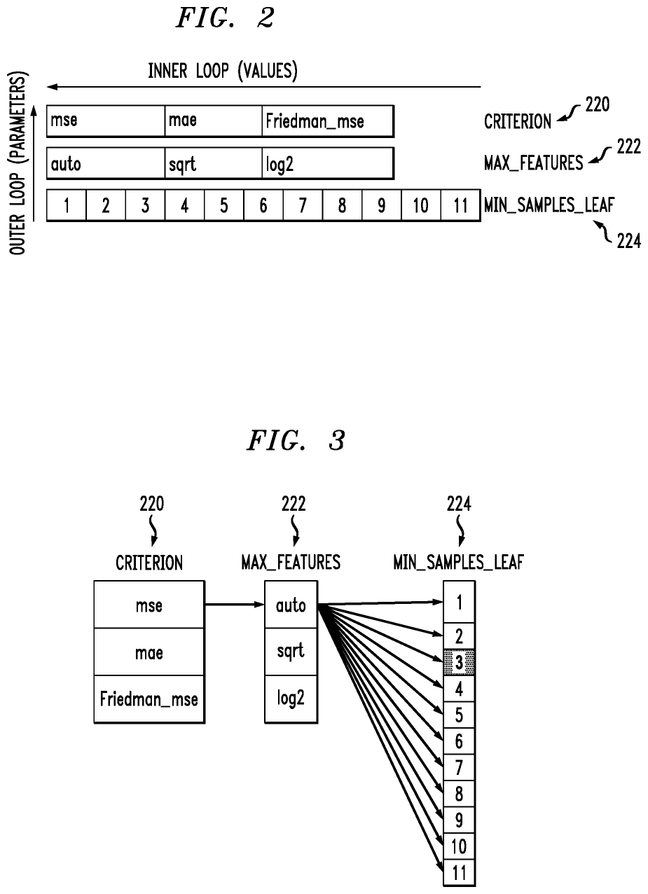

By way of example, in such an embodiment, an outer loop starts with the hyperparameters while an internal loop involves the values of a given hyperparameter. While the internal loop determines the optimized value of the given hyperparameter, the outer loop covers all hyperparameters and captures and incorporates each individual optimized value. By way of illustration, refer again to the above-noted example of the gradient boosting regressor algorithm and corresponding three hyperparameters. In an example embodiment, the three hyperparameters and their respective values are processed using an inner loop and an outer loop that traverse through the hyperparameters and the values, as shown in FIG. 2.

FIG. 2 shows example inner and outer loops of hyperparameters and values in an illustrative embodiment. As illustrated, the hyperparameters include criterion 220, max_features 222, and min_samples_leaf 224, and the corresponding values include ‘mse,’ ‘mae,’ and ‘Friedman_mse’ for hyperparameter 220, ‘auto,’ ‘sqrt,’ and ‘log 2’ for hyperparameter 222, and 1, 2, 3, 4, 5, 6, 7, 8, 9, 10, and 11 for hyperparameter 224. In accordance with at least one embodiment, the maximum value of iterations can be equal to the number of values of all hyperparameters. Mathematically it can be represented as:
p=n;
number of loops=Σval(p); and
p=0.

With the three hyperparameters given in the FIG. 2 example (i.e., criterion, max_features, and min_samples_leaf), the total number of iterations will be 3+3+11=17. This is a significant reduction from, for example, a GridSearchCV approach (which would include, for example, 3*3*11=99 iterations).

Steps in the inner loop that determine and push, to the outer loop, the optimized values of the hyperparameters depicted in the FIG. 2 example embodiment are illustrated in FIGS. 3-5.

FIG. 3 shows a portion of a machine learning hyperparameter tuning algorithm in an illustrative embodiment. By way of illustration, FIG. 3 depicts iteration on hyperparameters and their respective values. The arrow shown from criterion 220 to max_features 222 indicates that the hyperparameter in criterion 220 fixes the value in max_features 222, and then the looping occurs on at least a portion (e.g., all) values of the hyperparameter in min_samples_leaf 224. By way merely of illustration, in the FIG. 3 example, the inner loop goes through all values of hyperparameter min_samples_leaf 224, while the other two hyperparameters are fixed at max_features (222)=auto and criterion (220)=mse. Once the inner loop completes all values of min_samples_leaf 224 (e.g., looping through 11 values), the value of that parameter is set to the best value (which is 3 in the FIG. 3 example) for all future looping.

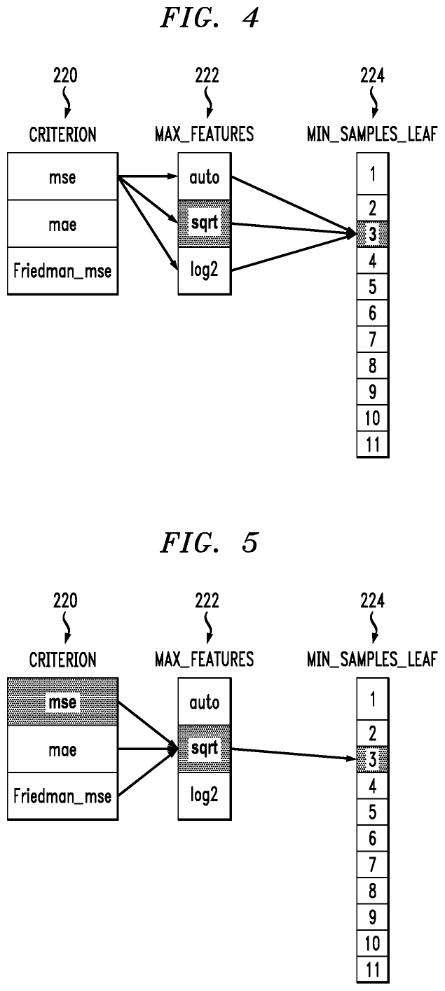

FIG. 4 shows a portion of a machine learning hyperparameter tuning algorithm in an illustrative embodiment. By way of illustration, FIG. 4 depicts a middle loop, occurring subsequent to the inner loop detailed in connection with FIG. 3 above, wherein such a middle loop moves to the second value of max_feature 222 to sqrt, while keeping the criterion 220 value fixed at mse and the min_samples_leaf set at 3.

FIG. 5 shows a portion of a machine learning hyperparameter tuning algorithm in an illustrative embodiment. By way of illustration, FIG. 5 depicts an outer loop, which would occur subsequent to the middle loop detailed in connection with FIG. 4 above. Accordingly, once the middle loop completes for all values of max_features 222, the outer loop continues with the second value of criterion 220 (here, mae) and then the third value of criterion 220 (here, Friedman_mse). Once all values of a hyperparameter are covered in an iteration, the best value is set for each subsequent looping, and the best values of at least a portion of all hyperparameters are selected. Specifically, in the FIG. 5 example, the outer loop iterates through all values of the criterion hyperparameter 220 while keeping the values of the other two hyperparameters 222 and 224 fixed at sqrt and 3, respectively.

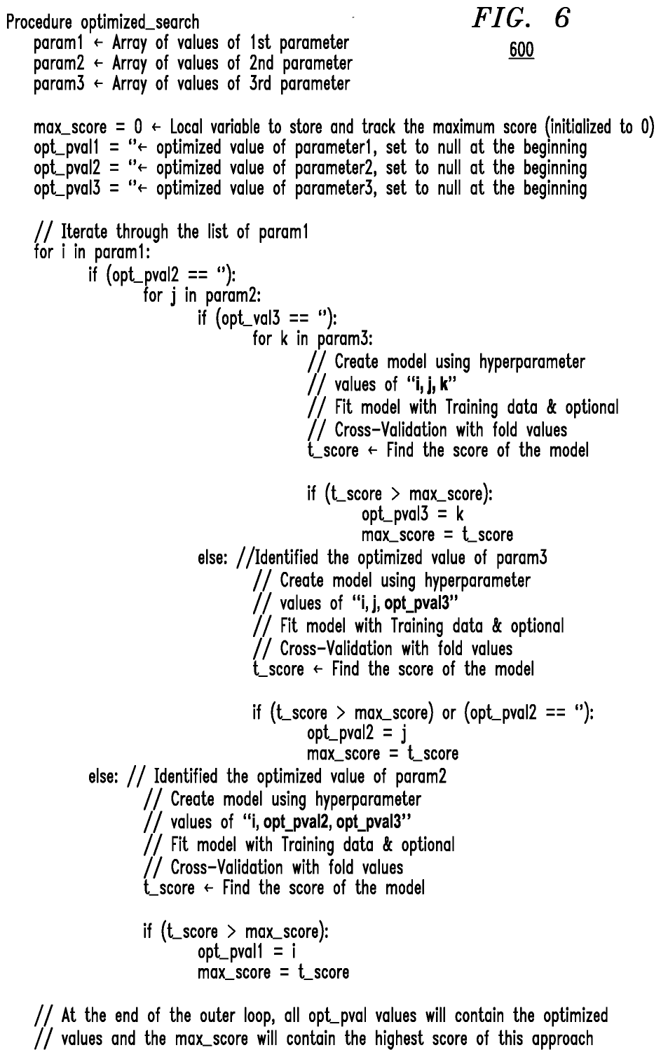

FIG. 6 shows example pseudocode for implementing at least a portion of a machine learning hyperparameter tuning algorithm in an illustrative embodiment. In this embodiment, example pseudocode 600 is executed by or under the control of at least one processing system and/or device. For example, the example pseudocode 600 may be viewed as comprising a portion of a software implementation of at least part of automated machine learning algorithm hyperparameter tuning system 105 of the FIG. 1 embodiment.

The example pseudocode 600 illustrates identifying the hyperparameters in question (here, the three hyperparameters (i.e., param1, param2, and param3) as detailed above in connection with FIGS. 2-5), as well as a respective array of values corresponding to each identified hyperparameter. Additionally, pseudocode 600 illustrates initializing to a value of zero a local variable (max_score) associated with storing and tracking the maximum score of the machine learning algorithm in question. Also, the optimized values of each hyperparameter (opt_pval1, opt_pval2, and opt_pval3) are initially set to null.

Pseudocode 600 further illustrates iterating through the array of values of the first hyperparameter (param1). Specifically, using a first value (i) for the first hyperparameter (param1), pseudocode 600 uses variables opt_pval1, opt_pval2, and opt_pval3, wherein these variables will store the optimized values of the three hyperparameters (e.g., criterion, max_features, and min_samples_leaf). In the inner loop, wherein iteration is carried out through all 11 values of min_samples_leaf, the optimized value of three is stored in opt_pval3. The check for that value is performed to make sure that the inner looping is complete. Also, in the beginning of the outer loop, the check of the value for opt_val2 is performed to make sure that the middle loop is completed and the optimized value for the second/middle hyperparameter is selected.

Also, pseudocode 600 details creating a model using hyperparameter values of i, j, and k, and fitting the model with training data and optionally performing cross-validation with fold values. Subsequently, the score of the created model (t_score) is determined, and if the t_score is greater than max_score, then pseudocode 600 determines that opt_pval3=k and the max_score is reset to equal t_score. As detailed herein, cross-validation is an approach used to find the durability of a model. Fold values are a type of hyperparameter that users can set (for example, set here in pseudocode 600 as three). In cross-validation, the training data are divided into a number of folds or groups (for example, three folds). The model can then be, for example, trained with two folds/groups of the training data, and then testing can be carried out using the third fold of training data. In one or more embodiments, the same process can continue with a different set of two folds/groups for training and a third fold/group for testing (that is, a different combination/arrangement of the three folds). In such an embodiment, this process continues until all three folds are tested and the best score of the three iterations is considered the score of the model. That iteration number (three, in this illustrative example) is referred to as the k value of cross-validation.

Further, pseudocode 600 uses the identified optimized value of param3 and creates a model using hyperparameter values of i, j, and opt_pval3, fitting the model with training data and optionally cross-validating the model with fold values. Subsequently, the score of the created model (t_score) is determined, and if this t_score is greater than max_score or if it is equal to opt_pval2, then pseudocode 600 determines that opt_pval2=j and the max_score is set to equal this t_score.

As also depicted in FIG. 6, pseudocode 600 uses the identified optimized value of param2 and creates a model using hyperparameter values of i, opt_pval2, and opt_pval3, fitting the model with training data and optionally cross-validating the model with fold values. Subsequently, the score of the created model (t_score) is determined, and if this t_score is greater than max_score, then pseudocode 600 determines that opt_pval1=i and the max_score is set to equal this t_score.

Pseudocode 600 additionally illustrates that, at the end of the outer loop determinations, all opt_pval values will contain the respective optimized values and the max_score will contain the highest score as determined by the machine learning hyperparameter tuning algorithm.

It is to be appreciated that this particular example pseudocode shows just one example implementation of a portion of a machine learning hyperparameter tuning algorithm, and alternative implementations of the process can be used in other embodiments.

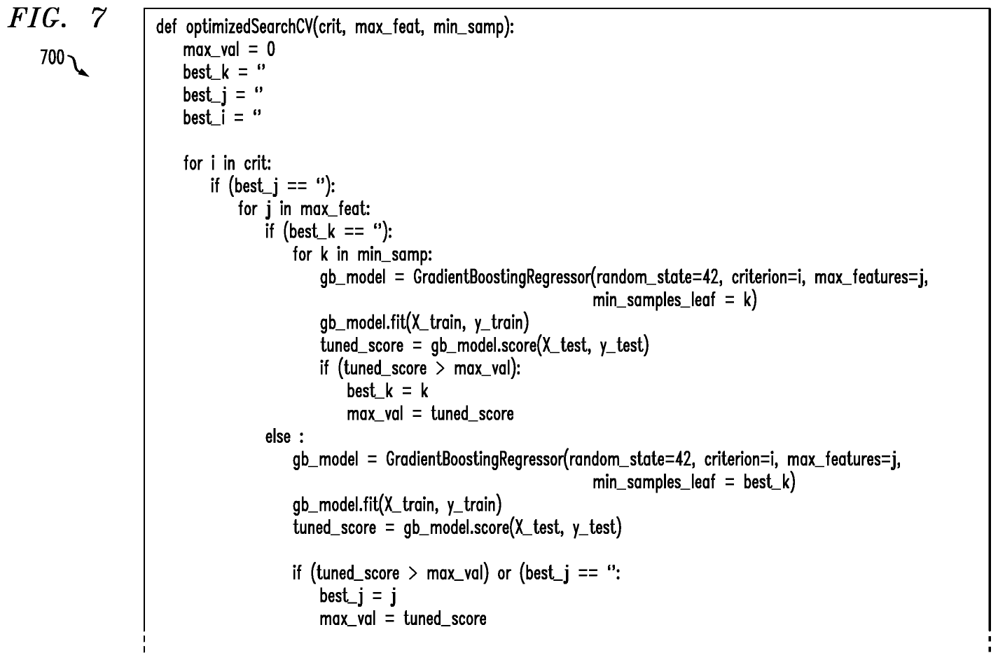

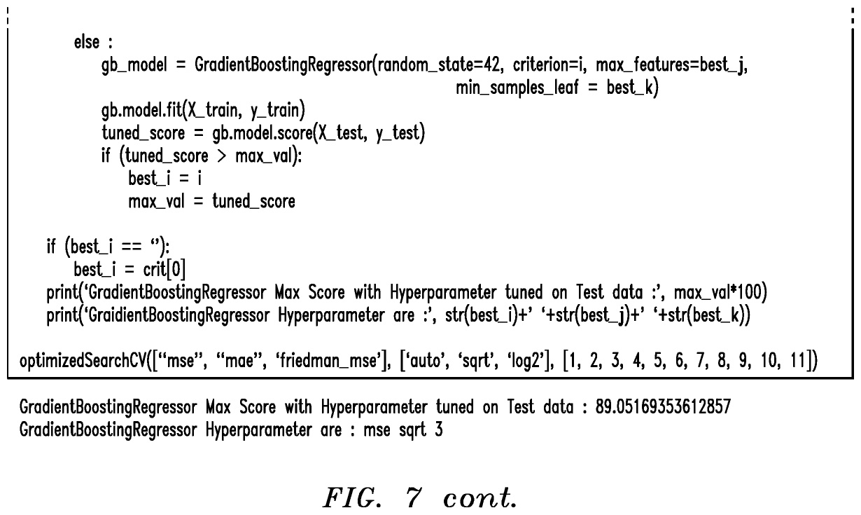

FIG. 7 shows an example code snippet for implementing at least a portion of a machine learning hyperparameter tuning algorithm without cross-validation in an illustrative embodiment. In this embodiment, example code snippet 700 is executed by or under the control of at least one processing system and/or device. For example, the example code snippet 700 may be viewed as comprising a portion of a software implementation of at least part of automated machine learning algorithm hyperparameter tuning system 105 of the FIG. 1 embodiment.

The example code snippet 700 illustrates identifying hyperparameters (e.g., crit, max_feat, and min_samp) for a given machine learning algorithm (e.g., a gradient boosting regressor algorithm). Similar to the pseudocode 600 depicted in FIG. 6, code snippet 700 illustrates implementing a recursive mechanism across the possible values of the noted hyperparameters, which includes generating versions of a model using various hyperparameter feature value combinations, scoring such versions, and ultimately determining the optimized value for each hyperparameter (e.g., mse, sqrt, and 3, as indicated in code snippet 700). The generated score (89.05169353612857, in code snippet 700) indicates the maximum score using the given hyperparameter tuning. During the looping and iterations of an example embodiment such as detailed in connection with FIG. 7, models are created and scores are generated (e.g., by calling a score function of the given model) and stored in a temporary variable. Every time a new score exceeds the old score value, the new score replaces the old score and the corresponding hyperparameter values are stored. Accordingly, at the end of an iteration, the given variable has the maximum score of the model and the hyperparameter values that are responsible for that score.

It is to be appreciated that this particular example code snippet shows just one example implementation of a portion of a machine learning hyperparameter tuning algorithm without cross-validation, and alternative implementations of the process can be used in other embodiments.

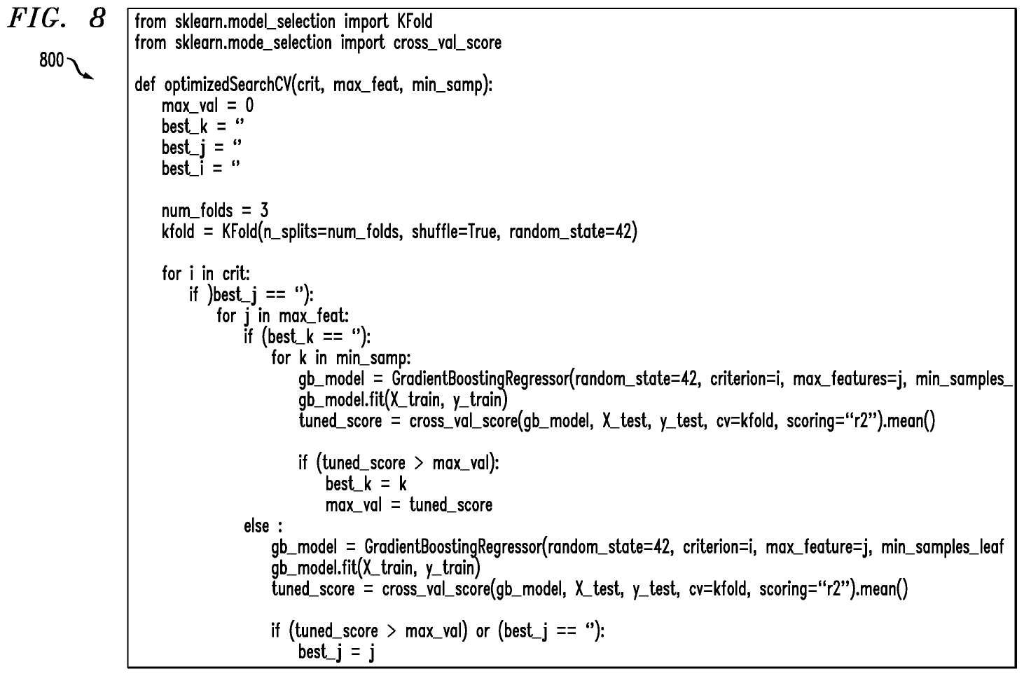

FIG. 8 shows an example code snippet for implementing at least a portion of a machine learning hyperparameter tuning algorithm with cross-validation in an illustrative embodiment. In this embodiment, example code snippet 800 is executed by or under the control of at least one processing system and/or device. For example, the example code snippet 800 may be viewed as comprising a portion of a software implementation of at least part of automated machine learning algorithm hyperparameter tuning system 105 of the FIG. 1 embodiment.

The example code snippet 800 illustrates code similar to at least a portion of code snippet 700 in FIG. 7 with the addition of a cross-validation technique. Specifically, code snippet 800 illustrates a cross-validation technique, as further detailed herein, using a k-fold with k value of three, which is used to train and score each generated model version.

It is to be appreciated that this particular example code snippet shows just one example implementation of a portion of a machine learning hyperparameter tuning algorithm with cross-validation, and alternative implementations of the process can be used in other embodiments.

FIG. 9 is a flow diagram of a process for automated hyperparameter tuning in a machine learning algorithm in an illustrative embodiment. It is to be understood that this particular process is only an example, and additional or alternative processes can be carried out in other embodiments.

In this embodiment, the process includes steps 900 through 906. These steps are assumed to be performed by automated machine learning algorithm hyperparameter tuning system 105 utilizing its elements 112, 114 and 116.

Step 900 includes identifying, for a given machine learning algorithm, two or more hyperparameters and at least a portion of possible values for each of the two or more hyperparameters. In at least one embodiment, the at least a portion of possible values for each of the two or more hyperparameters includes one or more of at least one categorical value and at least one numerical value. Additionally or alternatively, the at least a portion of possible values for each of the two or more hyperparameters varies in number of values.

Also, in one or more embodiments, the given machine learning algorithm includes one of an SVM algorithm, a random forest algorithm, a gradient boosting algorithm, a k-means clustering algorithm, a DBSCAN algorithm, an agglomerative clustering algorithm, and a neural network.

Step 902 includes determining an optimized value, among the at least a portion of possible values, for a first of the two or more hyperparameters by iterating through each of the at least a portion of the possible values for the first hyperparameter, generating a version of the given machine learning algorithm corresponding to each iteration, scoring each version of the given machine learning algorithm, and identifying the optimized value for the first hyperparameter based on the scoring of each version. In at least one embodiment, identifying the optimized value for the first hyperparameter includes comparing the scores of the scored versions of the given machine learning algorithm and selecting the value corresponding to the highest score.

Step 904 includes determining an optimized value, among the at least a portion of possible values, for at least a second of the two or more hyperparameters by iterating through each of the at least a portion of the possible values for the at least a second of the two or more hyperparameters, with each iteration being carried out in conjunction with using the identified optimized value for the first hyperparameter, generating a version of the given machine learning algorithm corresponding to each iteration, scoring each version of the given machine learning algorithm, and identifying at least one optimized value for the at least a second of the two or more hyperparameters based on the scoring of each version. In at least one embodiment, identifying the at least one optimized value for the at least a second of the two or more hyperparameters includes, for each of the at least one hyperparameters, comparing the scores of the scored versions of the given machine learning algorithm and selecting the value corresponding to the highest score. Additionally, in one or more embodiments, scoring each version of the given machine algorithm includes using at least one set of training data.

Step 906 includes automatically tuning the two or more hyperparameters of the given machine learning algorithm based at least in part on the determined optimized values. At least one embodiment can also include performing one or more cross-validation techniques on the given machine learning algorithm subsequent to the automatic tuning of the two or more hyperparameters. In such an embodiment, performing the one or more cross-validation techniques can include performing one or more k-fold cross-validation techniques, which can include using a number of folds equivalent to the number of hyperparameters comprised in the two or more hyperparameters of the given machine learning algorithm.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to determine optimized hyperparameter values in machine learning algorithms using an automated recursive mechanism. These and other embodiments can effectively overcome problems associated with error-prone and computationally expensive techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

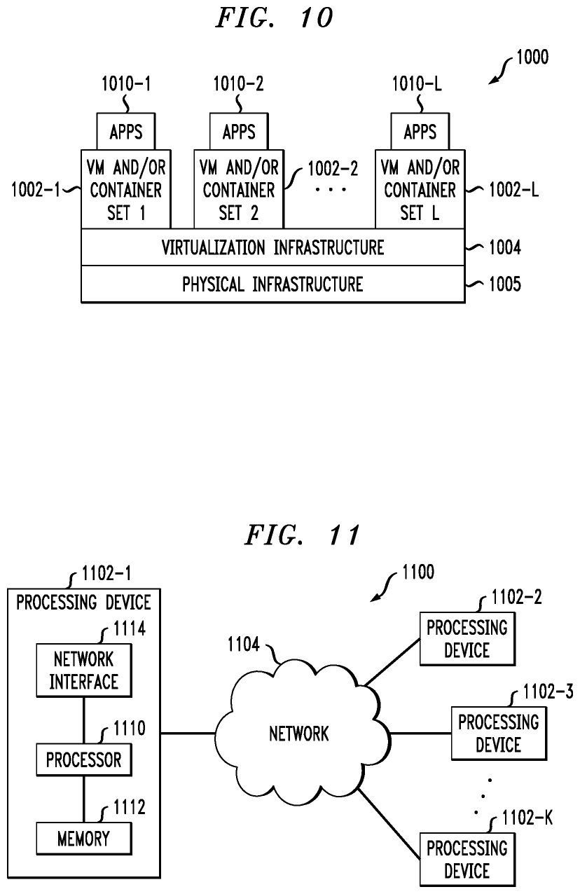

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, a microcontroller, an application-specific integrated circuit (ASIC), a field-programmable gate array (FPGA) or other type of processing circuitry, as well as portions or combinations of such circuitry elements.

The memory 1112 comprises random access memory (RAM), read-only memory (ROM) or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying, for a given machine learning algorithm, two or more hyperparameters and at least a portion of possible values for each of the two or more hyperparameters;
determining a first value, among the at least a portion of possible values, for a first of the two or more hyperparameters by iterating through each of the at least a portion of the possible values for the first hyperparameter, generating a version of the given machine learning algorithm corresponding to each iteration, scoring each version of the given machine learning algorithm, and identifying the first value based on the scoring of each version;
determining at least a second value, among the at least a portion of possible values, for at least a second of the two or more hyperparameters by iterating through each of the at least a portion of the possible values for the at least a second of the two or more hyperparameters, with each iteration being carried out in conjunction with using the identified first value for the first hyperparameter, generating a version of the given machine learning algorithm corresponding to each iteration, scoring each version of the given machine learning algorithm, and identifying the at least a second value for the at least a second of the two or more hyperparameters based on the scoring of each version; and
automatically tuning the two or more hyperparameters of the given machine learning algorithm based at least in part on the determined first value and the determined at least a second value;
wherein the method is performed by at least one processing device comprising a processor coupled to a memory.

2. The computer-implemented method of claim 1, further comprising:
performing one or more cross-validation techniques on the given machine learning algorithm subsequent to the automatic tuning of the two or more hyperparameters.

3. The computer-implemented method of claim 2, wherein performing the one or more cross-validation techniques comprises performing one or more k-fold cross-validation techniques.

4. The computer-implemented method of claim 3, wherein performing one or more k-fold cross-validation techniques comprises using a number of folds equivalent to the number of hyperparameters comprised in the two or more hyperparameters of the given machine learning algorithm.

5. The computer-implemented method of claim 1, wherein the first value comprises an optimized value for the first hyperparameter, and wherein identifying the optimized value for the first hyperparameter comprises comparing the scores of the scored versions of the given machine learning algorithm and selecting the value corresponding to the highest score.

6. The computer-implemented method of claim 1, wherein the at least a second value comprises at least one optimized value for the at least a second of the two or more hyperparameters, and wherein identifying the at least one optimized value for the at least a second of the two or more hyperparameters comprises, for each of the at least one hyperparameters, comparing the scores of the scored versions of the given machine learning algorithm and selecting the value corresponding to the highest score.

7. The computer-implemented method of claim 1, wherein the at least a portion of possible values for each of the two or more hyperparameters comprise one or more of at least one categorical value and at least one numerical value.

8. The computer-implemented method of claim 1, wherein the at least a portion of possible values for each of the two or more hyperparameters varies in number of values.

9. The computer-implemented method of claim 1, wherein the given machine learning algorithm comprises one of a support vector machines (SVM) algorithm, a random forest algorithm, a gradient boosting algorithm, a k-means clustering algorithm, a density-based spatial clustering of applications with noise (DBSCAN) algorithm, an agglomerative clustering algorithm, and a neural network.

10. The computer-implemented method of claim 1, wherein scoring each version of the given machine algorithm comprises using at least one set of training data.

11. A non-transitory processor-readable storage medium having stored therein program code of one or more software programs, wherein the program code when executed by at least one processing device causes the at least one processing device:
to identify, for a given machine learning algorithm, two or more hyperparameters and at least a portion of possible values for each of the two or more hyperparameters;
to determine a first value, among the at least a portion of possible values, for a first of the two or more hyperparameters by iterating through each of the at least a portion of the possible values for the first hyperparameter, generating a version of the given machine learning algorithm corresponding to each iteration, scoring each version of the given machine learning algorithm, and identifying the first value based on the scoring of each version;
to determine at least a second value, among the at least a portion of possible values, for at least a second of the two or more hyperparameters by iterating through each of the at least a portion of the possible values for the at least a second of the two or more hyperparameters, with each iteration being carried out in conjunction with using the identified first value for the first hyperparameter, generating a version of the given machine learning algorithm corresponding to each iteration, scoring each version of the given machine learning algorithm, and identifying the at least a second value for the at least a second of the two or more hyperparameters based on the scoring of each version; and
to automatically tune the two or more hyperparameters of the given machine learning algorithm based at least in part on the determined first value and the determined at least a second value.

12. The non-transitory processor-readable storage medium of claim 11, wherein the program code when executed by the at least one processing device further causes the at least one processing device:
to perform one or more cross-validation techniques on the given machine learning algorithm subsequent to the automatic tuning of the two or more hyperparameters.

13. The non-transitory processor-readable storage medium of claim 12, wherein performing the one or more cross-validation techniques comprises performing one or more k-fold cross-validation techniques, wherein performing one or more k-fold cross-validation techniques comprises using a number of folds equivalent to the number of hyperparameters comprised in the two or more hyperparameters of the given machine learning algorithm.

14. The non-transitory processor-readable storage medium of claim 11, wherein the first value comprises an optimized value for the first hyperparameter, and wherein identifying the optimized value for the first hyperparameter comprises comparing the scores of the scored versions of the given machine learning algorithm and selecting the value corresponding to the highest score.

15. The non-transitory processor-readable storage medium of claim 11, wherein the at least a second value comprises at least one optimized value for the at least a second of the two or more hyperparameters, and wherein identifying the at least one optimized value for the at least a second of the two or more hyperparameters comprises, for each of the at least one hyperparameters, comparing the scores of the scored versions of the given machine learning algorithm and selecting the value corresponding to the highest score.

16. An apparatus comprising:
at least one processing device comprising a processor coupled to a memory;
the at least one processing device being configured:
to identify, for a given machine learning algorithm, two or more hyperparameters and at least a portion of possible values for each of the two or more hyperparameters;
to determine a first value, among the at least a portion of possible values, for a first of the two or more hyperparameters by iterating through each of the at least a portion of the possible values for the first hyperparameter, generating a version of the given machine learning algorithm corresponding to each iteration, scoring each version of the given machine learning algorithm, and identifying the first value based on the scoring of each version;
to determine at least a second value, among the at least a portion of possible values, for at least a second of the two or more hyperparameters by iterating through each of the at least a portion of the possible values for the at least a second of the two or more hyperparameters, with each iteration being carried out in conjunction with using the identified first value for the first hyperparameter, generating a version of the given machine learning algorithm corresponding to each iteration, scoring each version of the given machine learning algorithm, and identifying the at least a second value for the at least a second of the two or more hyperparameters based on the scoring of each version; and
to automatically tune the two or more hyperparameters of the given machine learning algorithm based at least in part on the determined first value and the determined at least a second value.

17. The apparatus of claim 16, wherein the at least one processing device is further configured:
to perform one or more cross-validation techniques on the given machine learning algorithm subsequent to the automatic tuning of the two or more hyperparameters.

18. The apparatus of claim 17, wherein performing the one or more cross-validation techniques comprises performing one or more k-fold cross-validation techniques, wherein performing one or more k-fold cross-validation techniques comprises using a number of folds equivalent to the number of hyperparameters comprised in the two or more hyperparameters of the given machine learning algorithm.

19. The apparatus of claim 16, wherein the first value comprises an optimized value for the first hyperparameter, and wherein identifying the optimized value for the first hyperparameter comprises comparing the scores of the scored versions of the given machine learning algorithm and selecting the value corresponding to the highest score.

20. The apparatus of claim 16, wherein the at least a second value comprises at least one optimized value for the at least a second of the two or more hyperparameters, and wherein identifying the at least one optimized value for the at least a second of the two or more hyperparameters comprises, for each of the at least one hyperparameters, comparing the scores of the scored versions of the given machine learning algorithm and selecting the value corresponding to the highest score.
